(19) United States
(12) Patent Application Publication
(10) Pub. No.: US 2004/0055778 A1
(43) Pub. Date: Mar. 25, 2004

(54) Apparatus and method for a flexible cable coupling an emulator unit with a target processor

(76) Inventors: Ronald L. Lerner, Houston, TX (US); Roger W. Strane, Irwin, PA (US)

Correspondence Address: TEXAS INSTRUMENTS INCORPORATED, P O BOX 655474, M/S 3999, DALLAS, TX, 75265

(21) Appl. No.: 10/253,761

(22) Filed: Sep. 24, 2002

(51) Int. Cl. H01B 7/00

(52) U.S. Cl. 174/113 R

(57) ABSTRACT

A connector cable for electrically coupling an emulation unit with a target processor has a multiplicity of shielded cables. Each shielded cable includes a center conductor surrounded by a dielectric material. The dielectric material, in turn, is surrounded by an outer conductor. Finally, a second dielectric material surrounds the outer conductor. The outer conductors of the coaxial cable can be processed to couple mechanically the multiplicity of coaxial conductors into a single flexible unit.

### BACKGROUND OF THE INVENTION

1. Field of the Invention

This invention relates generally to digital signal processing systems and, more particularly, to providing an interface between a target processor an emulator unit. The cable coupling the emulator unit and the target processor must carry a multiplicity of signals.

2. Background of the Invention

The chips having at least one integrated circuit processing unit and/or at least one digital signal processor fabricated thereon have gotten increasingly complex. A chip can have literally dozens of individual processors included thereon. The testing of these chips along with the operation and validation of application-related software has become increasingly important and increasingly complex. To further complicate the problem, the test and debug procedure should generally be performed as rapidly as possible. All of these factors have converged to place stringent requirements of the interface between the processor(s) under test and the testing apparatus.

Currently, the interface to and testing of a chip involves apparatus dedicated to that purpose. Referring to FIG. 1, a block diagram of a test configuration is shown. The test configuration in the target processor (or chip) 12, an emulation unit 11 and a host processing unit 10. The host processing unit 10 and the emulation unit 11 are coupled by connector cable 14 and the emulation unit 11 and the target processor 12 are coupled by connector cable 15. As will be clear, the host processing unit 10 and the target processor 12 can be combined in a single component. The target processor 12 has conductors coupled to numerous paths in the circuitry of the target processor. In this manner, the time dependence of the monitored signals provides information concerning the operation and performance of the circuit. The signals from the target processor 12 are applied to the emulation unit 11 over cable 15. The emulation unit 11 acts as an interface between the signals generated by the target processor 12 and the data processing unit 10 where the signals are analyzed. For example, the connector cable 15 will typically have more conductors than the cable connector 14. Consequently, one of the functions of emulation unit 11 is to store the test signals until the transfer to the data processing unit 10 can be effected.

While the connector cable 14 between the data processing unit 10 and the emulation unit 11 is typically of a size to couple to a standard connector of a data processing unit 10, the connector cable 15 between the emulation unit and the target processor is frequently much larger. Referring to FIG. 2A and FIG. 2B, a typical ribbon connector cable 20 used to couple a target processor 12 and an emulation unit 11 is shown. The connector cable 20 has a connector 21A and 21B at each end. The connectors 21A and 21B couple to mating connectors on the target processor 12 and the emulation unit 11. The cable portion 25 of the connector cable 20 has multiplicity of conductors 23 embedded in a flexible insulating matrix material 22. The matrix material 22 can be plastic, rubber, or any other material that has suitable properties for constraining the conductors while insulating them from the other conductors. The matrix material 22, if required, must be flexible to accommodate a wide variety of relative positions of the target processor 12 and the emulation unit 11. Around the flexible matrix is a conducting material 24 to minimize the interaction with ambient electromagnetic fields and to prevent the signals carried by the conductors 23 from emitting radiation fields.

While the connector cable of the prior art has been used successfully, several disadvantages have been found. For example, the connector cable has proven not to be sufficiently flexible for use in field testing situations. Furthermore, the individual connector cable conductors generate cross-talk that can compromise the integrity of signal transmission and can limit the effective length and performance of the cable.

A need has therefore been felt for apparatus and an associated method having the feature of providing an improved cable for coupling an emulation unit and a target processor. It would be a further feature of the apparatus and associated method to provide a more flexible emulation unit/target processor connector cable. It would be a still further feature of the present invention to provide an emulation unit/target processor having a reduced cross-talk between the individual conductors. It would be yet a further feature of the present invention to provide improved skew relationships between the signals transmitted by the cable.

### SUMMARY OF THE INVENTION

The aforementioned and other features are obtained, according to the present invention, by fabricating an emulation unit/target processor connector cable from a multiplicity of electrically shielded cables. The electrically shielded cable have center conductor surrounded by a suitable dielectric material. Enclosing the dielectric material and center conductor is a conducting tube. Surrounding the conducting tube is a dielectric matrix. The dielectric matrix can be processed in such a manner that the neighboring coaxial cables can be physically connected to form a cable connector. The center conductors are coupled to the pins of the connectors at either end of the connector cable.

Other features and advantages of the present invention will be more clearly understood upon reading of the following description and the accompanying drawings and the claims.

### BRIEF DESCRIPTION OF THE DRAWINGS

FIG. 1 is a block diagram of the test/interface configuration for testing, validation or application program of a target processing unit or chip according to the prior art.

FIG. 2A illustrates a connector cable used in coupling an emulation unit with a target processor according to the prior art, while FIG. 2B is a cross-sectional view of the connector cable shown in FIG. 2A.

FIG. 3A illustrates the connector cable used in coupling an emulation unit and a target processor according to the present invention. FIG. 3B is a cross-sectional view of the connector cable of FIG. 3A, and FIG. 3C is a perspective view of the shielded cable.

### PREFERRED EMBODIMENT

1. Detailed Description of the Figures

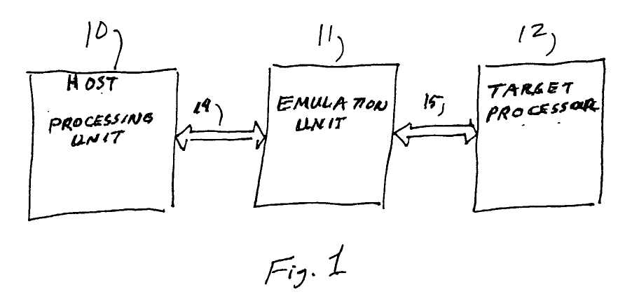

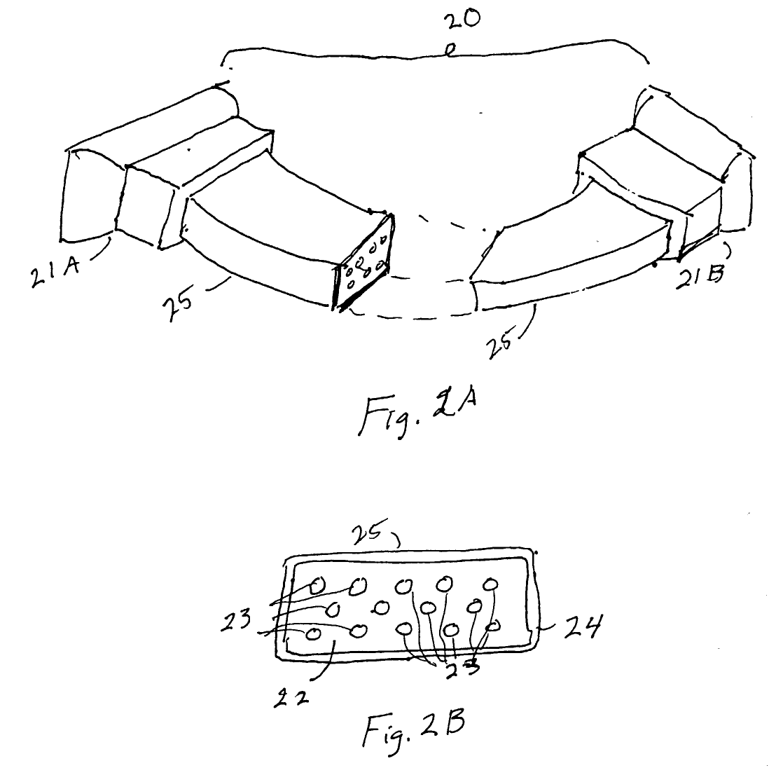

FIG. 1, FIG. 2A, and FIG. 2B have been described with respect to the prior art.

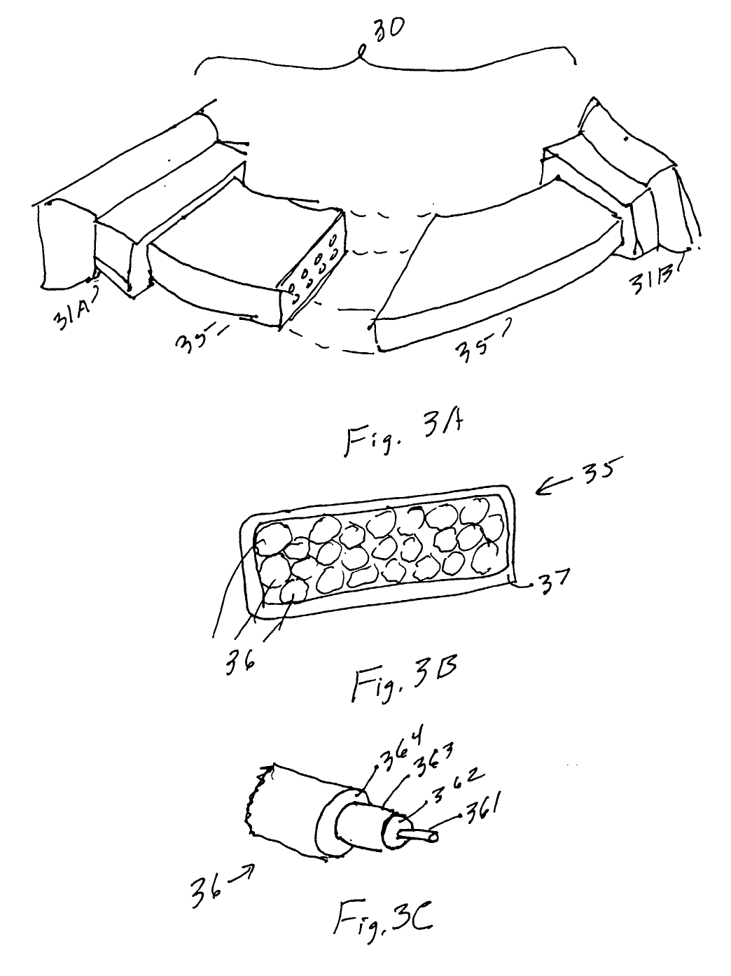

Referring to FIG. 3A, FIG. 3B, and FIG. 3C, the connector cable 30 for electrically coupling an emulation unit 11 and a target processor 12, according to the present invention, is shown. The connector cable includes cable body 35 with connectors 31A and 31B at either end of the cable body 35. FIG. 3b, a cross-sectional view of the cable body 35 illustrates that the connector cable body is fabricated from a multiplicity of small coaxial cables 36. The coaxial cables 36, shown in a perspective view in FIG. 3C, include a center conductor 361, an insulating dielectric material 362 surrounding the center conductor 361, a conducting tube 363 surrounding the dielectric material 362 and the center conductor 361, and a second dielectric material 363 surrounding the conducting tube 363. A surrounding cover 37 encloses the cable body. As will be clear to those skilled in the art, the conducting tube 363 is typically coupled to ground potential. However, the conducting tube 363 can be allowed to electrically “float” for certain applications.

The second dielectric material 361 is coupled to the dielectric material of adjoining coaxial cables 36 to form the connector cable body.

2. Operation of the Preferred Embodiment

The individual coaxial cables are extremely flexible and employed in many normally unacceptable configurations. When mechanically coupled together, some of the flexibility is lost. However, even with the lost flexibility, the connector cable of the present invention is more flexible than the connector cable of the prior art. The use of coaxial cables prevents cross-talk between the individual conductors. The outer cover protects the individual coaxial cables from stress tending to pull the coaxial cable for the cable body.

The connecting cable of the present invention has been described as being detachably coupled to components by electrical connectors. The connecting cable can be electrically coupled to the associated components by any accepted techniques.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A connector cable for coupling an emulation unit with a target processor, the connector cable comprising:
a multiplicity of shielded cables, each shielded cable including:
a center conductor;
a dielectric material surrounding the center conductor;
a conducting tube surrounding the dielectric material and the center conductor to form a shielded conductor; and
a second dielectric material surrounding the conducting tube;
wherein the second dielectric material is processed to couple mechanically to the second dielectric material of neighboring in coaxial cables.

2. The connector cable as recited in claim 1 further comprising a connector at each end and coupled to the multiplicity of shielded cables.

3. The connector cable as recited in claim 1 further comprising a cover, the cover surrounding the multiplicity of shielded cables.

4. The connector cable as recited in claim 1 wherein at least one of the conducting tubes is coupled to ground potential.

5. The connector cable as recited in claim 1 wherein at least one of the conducting tubes is electrically isolated from ground.

6. A method for electrically coupling a target processor and a test unit, the method comprising:
electrically coupling the target processor and a test unit with a multiplicity of shielded cables,
wherein each shielded cable is formed by:
coupling a multiplicity of conductors to the target processor and to the test unit;
surrounding each conductor with a conducting tube;
surrounding each conducting tube with an insulating material; and
mechanically coupling the insulating materials to form a bus.

7. The method as recited in claim 6 wherein at least one end of each of the multiplicity of conductors is electrically coupled to a cable connector.

8. The method as recited in claim 6 further including positioning a insulating material between each conductor and the surrounding conducting tube.

9. The method as recited in claim 8 further comprising the step of electrically coupling at least one conducting tube to ground potential.

10. A system for testing a target processor and/or application programs executing thereon, the system comprising:
a test unit; and
a connector cable, the electrical cable being coupled to the test unit, the connector cable capable of being detachably coupled to the target processor, the connector cable including:
a multiplicity of conductors;
an insulating material surrounding each conductor;
a conducting tube surrounding the insulating material of each conductor; and
an insulating material surrounding each conducting tube,
wherein the insulating material surrounding each conducting tube is mechanically coupled to the insulating material surrounding neighboring conducting tube.

11. The system as recited in claim 10 wherein at least one of conducting tubes is coupled to ground potential.

12. The system as recited in claim 10 wherein at least one of the conducting tubes is electrically isolated for ground potential.

13. The system as recited in claim 10 wherein the connector cable includes a cover surrounding the connector cable.

14. The system as recited in claim 10 wherein the connector cable includes a connector, the connector detachable coupled to the target processor.
